(19) United States
(12) Patent Application Publication
(10) Pub. No.: US 2010/0030912 A1
(43) Pub. Date: Feb. 4, 2010

(54) Method for the transmission of data in a communication network

(76) Inventors: Michael Finkenzeller, München (DE); Alejandro Ramirez, München (DE); Christian Schwingenschlögl, Putzbrunn (DE)

Correspondence Address: STAAS & HALSEY LLP, SUITE 700, 1201 NEW YORK AVENUE, N.W., WASHINGTON, DC, 20005, US

(21) Appl. No.: 12/311,313

(22) PCT Filed: Sep. 20, 2007
(86) PCT No.: PCT/EP2007/059941

§ 371 Date: Mar. 26, 2009

(30) Foreign Application Priority Data
Sep. 26, 2006 (DE) 10 2006 045 298.4

(51) Int. Cl. G06F 15/16

(52) U.S. Cl. 709/233

(57) ABSTRACT

A method for transmitting data in a communication network, features network management-controlled transmission of data via a data transmission channel that connects network nodes. According to the method, data is transmitted at a minimum desired transmission rate that results from a temporal usage of the data transmission channel.

### CROSS REFERENCE TO RELATED APPLICATIONS

This application is based on and hereby claims priority to PCT Application No. PCT/EP2007/059941 filed on Sep. 20, 2007 and German Application No. 10 2006 045 298.4 filed on Sep. 26, 2006, the contents of which are hereby incorporated by reference.

### BACKGROUND OF THE INVENTION

The invention lies in the technical field of communication networks and relates to a method for transmitting data in a communication network.

Quality of service (QoS), that is to say the totality of all quality features of a communication network from a user's viewpoint, is an important requirement facing all modern data transmission systems. Thus, the operators of communication networks are obligated to honor commitments relating to the quality of service of a communication network. The quality of service expresses itself for example in jitter (variation in latency from its mean value), latency (end-to-end transmission delay), loss rate (probability that individual data packets will get lost) and throughput (average volume of data transmitted per time unit). Although a promised quality of service is not required in all cases, it is important for a specific type of data traffic, such as the transmission of realtime data, for example.

Due to the proneness to error, quality of service is particularly important in wireless communication networks. However, wireless communication networks in particular have increased in popularity in the last several years, owing for example to the wireless connection of portable computers to the internet, with WLANs (WLAN=Wireless Local Area Network) conforming to the IEEE 802.11 standard being among the most frequently deployed wireless technologies.

An important aspect of the quality of service is the data transfer rate. For example, in the original IEEE 802.11 standard and the subsequent extensions to that standard different data transfer rates are specified which are made possible by different modulation and channel coding schemes. Thus, the IEEE 802.11 standard specifies the use of a physical data transfer rate of 1 Mbps (megabits per second) and 2 Mbps, the 802.11a extension supports data rates of up to 54 Mbps in the 5 GHz band based on OFDM technology (OFDM=Orthogonal Frequency Division Multiplexing), and the 802.11b extension supports data transfer rates of up to 11 Mbps in the 2.4 GHz band based on DSSS technology (DSSS=Direct Sequence Spread Spectrum). The extended 802.11g standard, which supports data rates of up to 54 Mbps in the 2.4 GHz band, was officially ratified in 2003.

In order to comply with certain quality of service requirements it appears useful to adjust the data transfer rate in a desired manner to changed conditions in the transmission channel. However, a change of this kind in the data transfer rate is not specified in the 802.11 standard and its supplements; rather, it is even explicitly excluded as going beyond the scope of the standard.

For this reason some chip manufacturers have gone over to developing data rate adaptation schemes which allow the data transfer rate to be adjusted to changed conditions in the wireless transmission channel.

For example, A. Kamerman et al. “WaveLAN-II: A high-performance wireless LAN for the unlicensed band” Bell Lab Technical Journal, pages 118-133, Summer 1997, contains a description of an algorithm for adapting the data transfer rate in which each transmitter attempts, after a fixed number of successful transmissions at a given data transfer rate, to use a higher data transfer rate, wherein after one or two successive errors a switch is made to a lower data transfer rate. When ten data packets have been successfully received or alternatively a timer has timed out, the data transfer rate is increased once more. However, implementing this algorithm is especially difficult, since this requires a change to the firmware of a standard configuration. That, however, is expressly forbidden in the USA and Europe by communication commissions.

In the above example, as also with other algorithms typically used in practice for the purpose of adjusting the data transfer rate, an attempt is always made to achieve the highest possible data transfer rate. In particular a maximum bit error rate is taken into account in this case, which is to say that the data transfer rate is chosen such that a maximum bit error rate will not be exceeded, in order thereby to maintain the quality of service pledged to the user. By bit error rate (BER) is meant the frequency of bit errors, which is to say the number of errors per time unit. For example, a bit error rate of 3-10⁻⁶ means that out of 1 million bits transmitted, 3 bits can be incorrect/lost on an average. In this case each chip manufacturer generally uses its own maximum bit error rate which is not to be exceeded.

The principal determining factor for the bit error rate is the distance between the sending station and the receiving station, since the distance-dependent signal-to-noise ratio, i.e. the ratio of information signal to interference signal, has a major influence on the bit error rate.

FIG. 1 shows by way of example a bit error rate (BER) plotted against the signal-to-noise ratio (SNR) at different data transfer rates. It is clear that the bit error rate decreases as the signal-to-noise ratio increases, while at the same time the data transfer rate can be increased.

Until now the chip manufacturers have tried to choose the data transfer rates so as to ensure that a specific maximum packet error rate is not exceeded. However, a configuration of this kind is only well suited to certain types of data traffic, while it is less well suited to other data traffic. For example, realtime data, such as internet telephony (VoIP=Voice over IP) and videoconferencing, as opposed to non-realtime data, requires a particularly low bit error rate, since the algorithms specified in IEEE 802.11 for recovering lost data packets are too slow for realtime applications, which means that a loss of data packets (frames) should be avoided as far as possible.

For this reason efforts have been directed over the last several years toward improving the IEEE 802.11 standard in terms of the quality of service, which efforts culminated in the IEEE 802.11e extension. The main element for supporting the quality of service is a centrally coordinating entity, the hybrid coordinator (HC), with a corresponding hybrid coordinator function (HCF) on the transmission medium. HC uses two methods for accessing the transmission medium: either via the enhanced distributed coordination function (EDCF) or via hybrid controlled channel access (HCCA). For that purpose HC introduces four access category (AC) and eight traffic stream (TS) queues on the MAC (Medium Access Control) layer. Incoming frames are provided with a traffic priority (TID). This can assume values between 0 and 15. Frames having a TID of 0 to 7 are mapped onto four ACs and then sent by EDCF. In the range between 8 and 15 the frame is mapped onto the traffic streams and then sent by controlled channel access using HCCA. In this way a strictly parameterized quality of service is supported in the case of the TS queues and a prioritized quality of service in the case of the AC queues. Another feature which has been introduced is the concept of transmission opportunity (TXOP). By this is meant a time interval in which a station may send. The transmission opportunity is referred to as EDCF TXOP if it was acquired in an EDCF competition phase, or as Polled TXOP, if it was acquired by a QoS poll frame of a QoS-enhanced AP (QAP). The maximum duration of a TXOP is determined by the TXOP limit value specified by the QAP.

The extended IEEE 802.11e standard also lifts the restriction whereby stations cannot communicate directly with one another in infrastructure mode. Under IEEE 802.11e, the stations no longer have to communicate via the access point (AP), but can exchange (only) traffic-specific data directly with one another via the Direct Link Protocol (DLP). The access point can reject the communication request. The available bandwidth is greatly increased as a result of this measure. Using DLP, the sending station first sends a direct link request message via the AP to the receiving station; the supported data rates and other information are transmitted in the message. As soon as the receiver has acknowledged these parameters, the direct link is established between the two stations. Data can then be exchanged directly between sender and receiver. If no more data is transferred, the direct link is severed after a certain time by a timeout. After this, data is once again transferred via the AP.

On the subject of enhancing the quality-of-service features in the extended IEEE 802.11e standard, mention should finally also be made of the block acknowledgements (Block ACKs). Until now, WLANs conforming to IEEE 802.11 have used a simple stop-and-wait ACK. However, a substantial overhead is created as a result of this method due to the immediate confirmation by an acknowledgement (ACK). With block ACKs, a group of data packets can be transferred en bloc. The receiver then transfers only one block ACK to the sender. Therein it is specified how many of the packets have been correctly received, thereby increasing channel efficiency.

Basically the extended IEEE 802.11e standard is intended to prevent low-priority data traffic disrupting higher-priority data traffic. However, no provision is made therein for a change to the transmission speed in the physical layer (PHY).

### SUMMARY

In contrast, one potential object is to disclose a method for transmitting data in a communication network by which the quality of service in the transmission channel can be adapted in line with changed transmission conditions in the transmission channel or, as the case may be, in line with the type of data traffic.

The inventors propose a method for transmitting data in a communication network (communication system) in which a transmission of data over a data transmission channel connecting network nodes under the control of a network management entity (control device). The network management entity (network management device or control device) for controlling the data transfer can be a centralized network management entity or a decentralized network management entity distributed in particular over the network nodes. It is important in this case that for the purpose of the data transfer in a data transmission channel the network management entity defines a minimum data transfer rate which is a minimum required data transfer rate resulting from a time-related occupation of the data transmission channel with data traffic.

The data transfer rates available for the data transfer in a transmission channel can be in particular data transfer rates specified by a standard such as 802.11e or proprietary data transfer rates used by a chip manufacturer.

The required data transfer rate resulting from the time-related occupation of the transmission channel ensures that the data transfer rate fulfills the user's requirements. The minimum required data transfer rate is therefore a data transfer rate which enables the intended data traffic to be transmitted within a timeframe provided herefor at an optimal bit error rate.

In an advantageous embodiment of the method, a data transfer rate supported by the network management entity is chosen for the data transmission which leads to a minimum bit error rate in the data transmission. This is important in particular when exclusively realtime data is to be transferred over the data transmission channel.

In a further advantageous embodiment of the method, a data transfer rate supported by the network management entity is chosen for the data transmission as a function of the type of data traffic that is to transmitted. If, for example, realtime data only is to be transferred over the transmission channel, then it is advantageous if a data transfer rate is chosen for the data transmission which results in a minimum bit error rate during the data transmission. If other, less QoS-sensitive data traffic is to be transmitted over a transmission channel simultaneously with the realtime data, it can be appropriate to allow a greater bit error rate than the minimum bit error rate in order thereby to make sufficient time available for the transmission of the other data traffic.

The proposed method can be applied particularly advantageously to data transmission in a wireless communication network. A wireless communication network of this type can be based in particular on the IEEE 802.11e standard. In this case it is advantageous if a data transfer rate is chosen as a function of parameters of the traffic specification (TSPEC) element, provided data is contained in the TSPEC element. A data transfer rate can also be chosen as a function of measurable data traffic parameters.

In a further advantageous embodiment of the method, the type of data traffic, in particular the presence of time-sensitive realtime data, is identified via higher layers of the communication network. Alternatively this can be accomplished by way of what is termed fingerprint detection, such as the detection of frame size and/or time period of a packet generation, or the identification of the port at which an IP connection is present.

The inventors also propose an electronic, centralized or decentralized, network management entity (network management device or control device) that is suitable for data processing and is embodied for controlling the data transmission in a communication network, which network management entity is provided with a program code containing control commands which cause the network management entity to carry out a method such as that described above.

The inventors furthermore propose a network node of a communication network. This network node is part of a decentralized network management entity for controlling the data transmission in a communication network and is provided with a program code containing control commands which cause the network management entity to carry out a method such as that described above.

In addition the inventors propose a machine-readable program code (computer program) for a network management entity that is suitable for data processing and is embodied for controlling the data transmission in a communication network, which program code contains control commands which cause the network management entity to carry out a method such as that described above.

A storage medium (computer program product) stores a machine-readable program code as described above.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows by way of example a bit error rate (BER) plotted against the signal-to-noise ratio (SNR) as a function of the data transfer rate (Mbps) of a wireless communication network;

FIG. 2 shows the structure of a traffic specification element format of the IEEE 802.11e WLAN standard.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

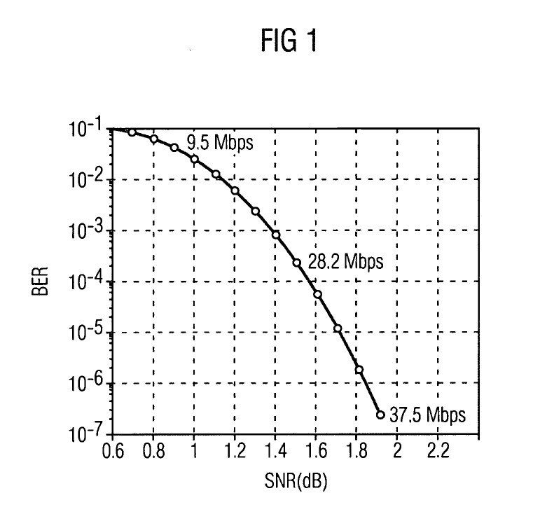

FIG. 1 has already been explained in the introduction to the description, so a further description here is unnecessary

In the exemplary embodiment a data transfer is performed in a wireless communication network based on the extended IEEE 802.11e standard. In this case the data transfer rate is chosen such that a data transmission takes place at a minimum required data transfer rate resulting from a time-related occupation of the data transmission channel. In particular the data transfer rate is chosen here as a function of the type of data traffic.

A parameter specified in an information field of the traffic specification (TSPEC) element format of the extended IEEE 802.11e standard can be used for the purpose of choosing a traffic-dependent data transfer rate.

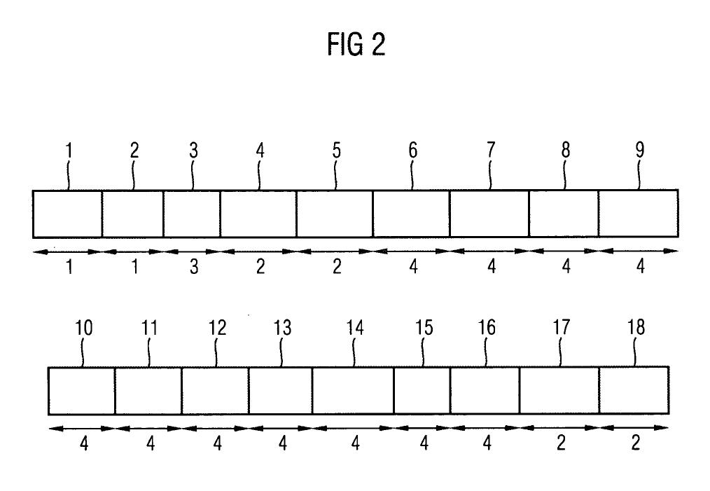

FIG. 2 shows the structure of the TSPEC format. Provided according thereto are the information fields “Element ID” 1, “Length” 2, “TS Info” 3, “Nominal MSDU Size” 4, “Maximum MSDU Size” 5, “Minimum Service Interval” 6, “Maximum Service Interval” 7, “Inactivity Interval” 8, “Suspension Interval” 9, “Service Start Time” 10, “Minimum Data Rate” 11, “Mean Data Rate” 12, “Peak Data Rate” 13, “Burst Size” 14, “Delay Bound” 15, “Minimum PHY Rate” 16, “Surplus Bandwidth Allowance” 17 and “Medium Time” 18. In this case the data transfer rate can be chosen using in particular the information field “Minimum PHY Rate” 16, in which a minimum data transfer rate in the physical layer (PHY) is specified.

In principle the algorithm for determining the data transfer rate on the transmission channel can be based on measurable data traffic parameters, such as bit rate, data packets/second, bit error rate, distance between nodes, and/or the information fields of the TSPEC element, provided data is contained in the information fields of the TSPEC element.

In the event that only a single realtime data traffic stream, such as VoIP data or videoconferencing data, is to be transferred over a data transmission channel, the data transfer rate specified in the information field “Minimum PHY Rate” 16 of the TSPEC element can be chosen as the data transfer rate for transmitting data over the data transmission channel, provided data is present in the information field. In the event that other data traffic streams are to be transferred in addition to the realtime data traffic stream, it can be more appropriate for the hybrid controller to determine a higher data transfer rate on the physical layer so that sufficient time is available for the transmission of the other data traffic stream in the data transmission channel. The hybrid controller is the centralized bandwidth manager which continuously monitors and determines the best configuration of the communication network in order to achieve optimal performance. Usually it is located in the access point and is responsible for controlling access to the transmission medium and informing the clients about the communication parameters used.

The type of data traffic can be determined via the higher layers of the communication network (layers 3-7 in the OSI model). Alternatively the lower layers (layers 2-4 in the OSI model) can detect the presence of time-critic realtime data traffic, for example by the use of filters or what is termed “fingerprint” detection, such as the detecting of frame size and/or time period of a packet generation of a connection. Identification of the port at which an IP connection is present can also be used for this purpose.

Although the use of a highest possible data transfer rate in a physical layer enables a faster transmission of frames and leaves the channel free for a longer time, data packets can be lost due to the higher bit error rate associated therewith, with the period of time for detecting a lost data packet being very long (up to one second). During the transmission of realtime data, therefore, not even the fastest packet retransmission can avoid problems with the transmission quality. However, non-time-sensitive applications can also benefit from the proposed method, since a low bit error rate means less packet loss, which under certain conditions can result in a higher throughput compared with a higher data transfer rate.

A table is required inside each network node in order to track the data transfer rate chosen for each link on the physical layer. A table of this kind can be updated constantly or at regular intervals. One possibility is to convert the variable relating to the current data transfer rate of the physical layer “current PHY rate”, which is already present in all WLAN maps, into a field which can use the traffic ID (TID) field as an index for each of the “current PHY rates” corresponding to each traffic flow. A further possibility is to implement a separate table containing this information in the firmware. A further possibility is to use the already existing table, with the TSPECs being reserved for storing this information. Since the “current PHY rate” for each traffic flow is dynamically adjusted to the current conditions of the wireless transmission channel, the possibility of updating this value if necessary must be provided.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-17. (canceled)

18. A method of transmitting data in a communication network, comprising:
transmitting data over a data transmission channel connecting network nodes controlled by a network management entity, the data transmission being performed at a minimum required data transfer rate resulting from a time-related occupation of the data transmission channel.

19. The method as claimed in claim 18, wherein the data transfer rate corresponds to a minimum bit error rate.

20. The method as claimed in claim 18, wherein the data transfer rate corresponds to a minimum data transfer rate supported by the network management entity.

21. The method as claimed in claim 18, wherein the data transfer rate is based on a type of data traffic.

22. The method as claimed in claim 21, wherein the data traffic includes realtime data.

23. The method as claimed in claim 22, wherein the realtime data is Voice-over-IP data.

24. The method as claimed in claim 21, wherein the data traffic includes only realtime data.

25. The method as claimed in claim 24, wherein the realtime data is Voice-over-IP data.

26. The method as claimed in claim 18, wherein the communication network is a wireless communication network.

27. The method as claimed in claim 26, wherein the wireless communication network is based on the IEEE 802.11e standard.

28. The method as claimed in claim 18, wherein the data transfer rate is based on parameters of a traffic specification element.

29. The method as claimed in claim 18, wherein the data transfer rate is based on measurable data traffic parameters.

30. The method as claimed in claim 21, wherein the data traffic type is identified via higher layers of the communication network.

31. The method as claimed in claim 21, wherein the data traffic type is identified via fingerprint detection of the data traffic type.

32. The method as claimed in claim 21, wherein the data traffic type is detected via an identification of a port at which an IP connection is present.

33. The method as claimed in claim 18, wherein the network management entity is a decentralized network management entity, and each of the network nodes are part of the decentralized network management entity.

34. A communication network, comprising:
a plurality of network nodes each connected by a data transmission channel; and
a network management entity controlling data transmission over the data transmission channel in the communication network, the data transmission being performed at a minimum required data transfer rate resulting from a time-related occupation of the data transmission channel.
